(19) United States
(12) Patent Application Publication
(10) Pub. No.: US 2024/0427723 A1
(43) Pub. Date: Dec. 26, 2024

(54) STORAGE DEVICES CONNECTORS

(71) Applicant: Hewlett-Packard Development Company, L.P., Spring, TX (US)

(72) Inventors: Charles J. Stancil, Spring, TX (US); Charles N. Shaver, Spring, TX (US)

(73) Assignee: Hewlett-Packard Development Company, L.P., Spring, TX (US)

(21) Appl. No.: 18/703,027

(22) PCT Filed: Nov. 15, 2021
(86) PCT No.: PCT/US2021/059398

§ 371 Date: Apr. 19, 2024

(51) Int. Cl. G06F 13/40

(52) U.S. Cl. CPC G06F 13/4081; G06F 13/4022; G06F 13/4059

(57) ABSTRACT

In some examples, an electronic device includes a connector, a first switch to control, responsive to a signal, providing of a first voltage signal to the connector, a second switch to control, responsive to the signal, providing of a second voltage signal to the connector, and a controller. The controller is to determine, responsive to the signal, a type of a storage device couple to the connector, and enable, responsive to the type of the storage device, a set of signals to the connector.

### BACKGROUND

Electronic devices such as televisions, notebooks, laptops, desktops, tablets, and smartphones are equipped with connectors that enable different hardware components to couple to the electronic device. For instance, an M.2 connector enables different storage devices to couple to a communications bus of an electronic device.

### BRIEF DESCRIPTION OF THE DRAWINGS

Various examples are described below referring to the following figures.

FIG. 1 is a block diagram depicting an electronic device for enabling a storage device to couple to a communications bus, in accordance with various examples.

FIG. 2 is a flow diagram depicting a method for an electronic device to enable a storage device to couple to a communications bus, in accordance with various examples.

FIG. 3 is a block diagram depicting an electronic device for enabling a storage device to couple to a communications bus, in accordance with various examples.

FIG. 4 is a flow diagram depicting a method for an electronic device to enable a storage device to couple to a communications bus, in accordance with various examples.

FIG. 5 is a block diagram depicting an electronic device for enabling a storage device to couple to a communications bus, in accordance with various examples.

FIG. 6 is a flow diagram depicting a method for an electronic device to enable a storage device to couple to a communications bus, in accordance with various examples.

### DETAILED DESCRIPTION

As described above, electronic devices are equipped with connectors that enable different storage devices to couple to communications buses of the electronic devices. A connector for enabling a storage device to couple to a communications bus interfaces the storage device to the communications bus according to a standard or a specification. For instance, an M.2 connector enables an expansion card mounted within the electronic device to couple to a storage device utilizing a Peripheral Component Interconnect Express (PCIe) interface or a Serial AT Attachment (SATA) interface. However, not all storage devices utilize the PCIe or SATA interfaces. For instance, an Embedded MultiMedia Card (eMMC) storage device does not utilize the PCIe or SATA interfaces. To enable the M.2 connector to couple to a storage device that does not utilize the PCIe or SATA interfaces, a bridge circuit is utilized to couple the storage device that does not utilize the PCIe or SATA interfaces to the PCIe interface. In some instances, the bridge circuit utilizes terminals of the M.2 connector in ways that are not in accordance with a standard associated with the M.2 connector. Utilizing terminals of the M.2 connector in ways that are not in accordance with the standard may interfere with operations when the electronic device communicates with other types of storage devices (e.g., hard disk drive (HDD), solid state drive (SSD), hybrid drives) coupled to the M.2 connector via the PCIe or SATA interfaces.

This description describes an electronic device that utilizes switches, buffers, or a combination thereof, to control propagation of a set of signals between components that are coupled to a communications bus. The set of signals, as used herein, include data signals, command signals, clock signals, and other signals associated with operations of the components. A type of a storage device coupled to a connector is determined based on a value of a signal propagated via the connector to the communications bus. Responsive to the type indicating a first type of storage device, a first switch enables providing of a first voltage signal to the storage device, a second switch enables providing of a second voltage signal to the storage device, a set of buffers enables the set of signals to flow between a controller coupled to the communications bus and the storage device, or a combination thereof. Responsive to the type indicating a second type of storage device, the first switch disables providing of the first voltage signal to the storage device, the second switch disables providing of the second voltage signal to the storage device, the set of buffers disables the set of signals from flowing between the controller and the storage device, or a combination thereof.

In various examples, the controller determines the type of the storage device. Responsive to a determination that the type of the storage device is the first type, the controller causes a voltage supply circuit to supply the first voltage signal to the first switch and the second voltage signal to the second switch for respective providing to the first type of storage device. Responsive to a determination that the type of the storage device is the second type, the controller causes the voltage supply circuit to disable supply of the first voltage signal to the first switch and the second voltage signal to the second switch. In some examples, responsive to enablement of the voltage for the first type of storage device, the storage device communicates with other components of the electronic device via a first set of terminals of the connector. Responsive to disablement of the voltage signal for the first type of storage device, the storage device communicates with other components of the electronic device via a second set of terminals of the connector.

Utilizing the switches, the buffers, or the combination thereof, enables the electronic device to support an eMMC storage device, which provides high capacity storage while utilizing less voltage than other types of storage devices. The electronic device interchangeably supports both the eMMC storage device and other types of storage devices that utilize the PCIe interface via a same connector (e.g., the M.2 connector). So, utilizing the switches, buffers, or the combination thereof, enables support of the eMMC storage device without additional hardware components, such as the bridge circuit or an additional, separate connector for the eMMC storage device. Additionally, the switches, the buffers, or the combination thereof, do not interfere with operations when the electronic device communicates with other types of storage devices that utilize the PCIe interface.

In some examples in accordance with the present description, an electronic device is provided. The electronic device includes a connector, a first switch to control, responsive to a signal, providing of a first voltage signal to the connector, a second switch to control, responsive to the signal, providing of a second voltage signal to the connector, and a controller. The controller is to determine, responsive to the signal, a type of a storage device coupled to the connector, and enable, responsive to the type of the storage device, a set of signals to the connector.

In other examples in accordance with the present description, an electronic device is provided. The electronic device includes a connector having multiple terminals, the connector to couple to a storage device, a transistor having a gate to receive a signal from a first terminal of the connector, a source coupled to a voltage supply circuit, and a drain coupled to a second terminal of the connector, the transistor to enable a voltage signal of the voltage supply circuit to propagate to the second terminal of the connector responsive to the signal having a low value, and a buffer having a control input to receive the signal from the first terminal of the connector, a data input coupled to a controller, and an output coupled to a third terminal of the connector, the buffer to enable signals to propagate from the controller to the third terminal of the connector responsive to the signal having the low value.

In yet other examples in accordance with the present description, an electronic device is provided. The electronic device includes a connector to couple to a storage device, the coupling providing a signal, the signal having a first value responsive to the storage device having a first type and a second value responsive to the storage device having a second type. The electronic device also includes a first transistor to control, responsive to reception of the signal at a first gate, providing of a first voltage signal to the connector, a second transistor to control, responsive to reception of the signal at a second gate, providing of a second voltage signal to the connector, and a buffer to control, responsive to reception of the signal at a control input, propagation of a set of signals between a controller and the connector.

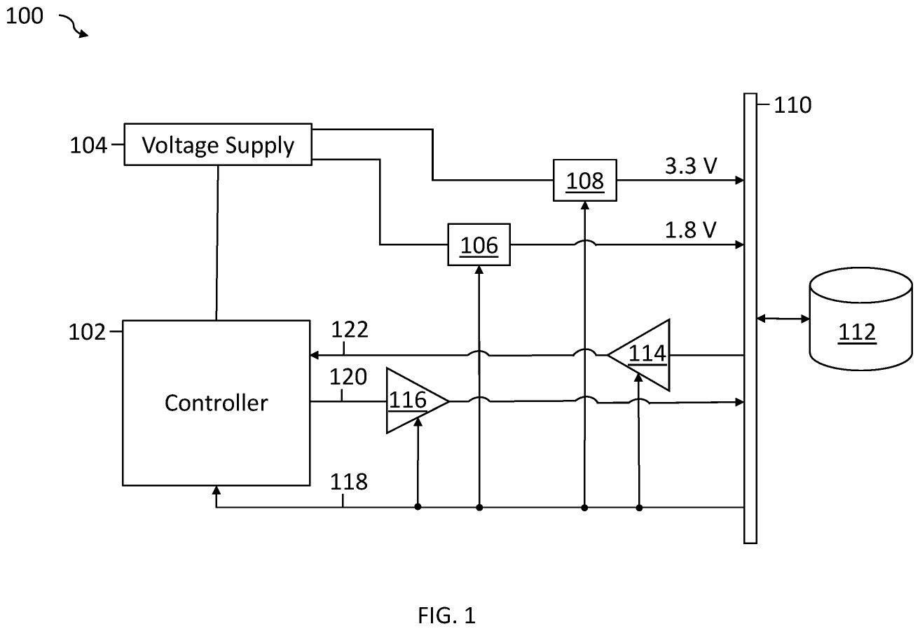

Referring now to FIG. 1, a block diagram depicting an electronic device 100 for enabling a storage device 112 to couple to a communications bus is provided, in accordance with various examples. The electronic device 100 is a television, notebook, laptop, desktop, tablet, smartphone, or other suitable electronic device equipped with a connector 110 that enables a storage device 112 to couple to the communications bus. The communications bus, as used herein, is a path that enables the transmission and receipt of signals between the components coupled to the path. The electronic device 100 includes a controller 102, a voltage supply circuit 104, switches 106, 108, the connector 110, the storage device 112, buffers 114, 116, and paths 118, 120, 122. The paths 120, 122 are herein referred to collectively as the communications bus.

The controller 102 is a microprocessor, a microcomputer, a microcontroller, a programmable integrated circuit, a programmable gate array, or other suitable device for managing operations of the electronic device 100 or a component or multiple components of the electronic device 100. For example, the controller 102 is a central processing unit (CPU), a graphics processing unit (GPU), or an embedded security controller (EpSC). In another example, the controller 102 is a controller that enables other components to communicate with the storage device 112. The voltage supply circuit 104 is any suitable circuit for supplying and regulating direct current (DC) voltage signals. The switches 106, 108 are any suitable devices for enabling and disabling a coupling between components of the electronic device 100. The switches 106, 108 are transistors, for example. In other examples, the switches 106, 108 are electromechanical relays. The connector 110 is any suitable connector that enables the storage device 112 to couple to the communications bus of the electronic device 100. The connector 110 is an M.2 connector, for example. The storage device 112 is a hard drive, a solid-state drive (SSD), flash memory, random access memory (RAM), or other suitable memory for storing data or machine-readable instructions of the electronic device 100. The storage device 112 is a storage device that operates according to the eMMC standard and utilizes an eMMC interface, for example, and is herein referred to as an eMMC storage device. In another example, the storage device 112 is a storage device that operates according to a Non-Volatile Memory Express (NVMe) standard and utilizes a PCIe interface, for example, and is herein referred to as an NVMe storage device. The buffers 114, 116 are any suitable circuits for controlling a flow of signals from the storage device 112 to the controller 102. The buffers 114, 116 are tri-state digital buffers having a data input, a control input, and an output, where the control input controls the flow of signals, for example.

In various examples, the controller 102 is coupled to the voltage supply circuit 104, the switches 106, 108 via the path 118, the connector 110 via the path 118, the buffers 114, 116 via the path 118, a buffer 114 via the path 122, and a buffer 116 via the path 120. The voltage supply circuit 104 is coupled to the controller 102 and the switches 106, 108. A switch 106 is coupled to the voltage supply circuit 104, the connector 110 via the path 118, a switch 108 via the path 118, the buffers 114, 116 via the path 118, and the connector 110 via a 1.8 volt (V) path. The switch 108 is coupled to the voltage supply circuit 104, the connector 110 via the path 118, the switch 106 via the path 118, the buffers 114, 116 via the path 118, and the connector 110 via a 3.3 V path. The connector 110 is coupled to the switch 106 via the 1.8 V path and the path 118, the switch 108 via the 3.3 V path and the path 118, the storage device 112, the buffer 114 via the paths 118, 122, the buffer 116 via the paths 118, 120, and the controller 102 via the path 118. The storage device 112 is coupled to the connector 110. The buffer 114 is coupled to the connector 110 via the paths 118, 122, the controller 102 via the paths 118, 122, the switches 106, 108 via the path 118, and the buffer 116 via the path 118. The buffer 116 is coupled to the connector 110 via the paths 118, 120, the controller 102 via the paths 118, 120, the switches 106, 108 via the path 118, and the buffer 114 via the path 118. The path 118 is coupled to the controller 102, the switches 106, 108, the connector 110, and the buffers 114, 116. The path 120 is coupled to the buffer 116, the connector 110, and the controller 102. The path 122 is coupled to the buffer 114, the connector 110, and the controller 102.

As described above, the electronic device 100 utilizes the switches 106, 108, the buffers 114, 116, or a combination thereof, to control voltage signals to the storage device 112, propagation of signals between the storage device 112 and the controller 102, or a combination thereof. The electronic device 100 utilizes a signal on the path 118 to control the switches 106, 108, the buffers 114, 116, or a combination thereof, for example. In various examples, the electronic device 100 utilizes the signal on the path 118 to control the switches 106, 108 to enable and disable voltage signals to the storage device 112 via the connector 110. In some examples, the electronic device 100 utilizes the signal on the path 118 to control the buffers 114, 116 to control transmission of signals between the controller 102 and the storage device 112 via the communications bus. For example, the buffer 116 controls, responsive to the signal on the path 118, transmission of signals from the controller 102 to the storage device 112 via the path 120. The buffer 114 controls, responsive to the signal on the path 118, transmission of signals from the storage device 112 to the controller 102 via the path 122.

In various examples, responsive to a first type of storage device coupling to the connector 110, a signal on the path 118 is driven low. Low, as used herein, indicates that a value of the signal on the path 118 is below a specified threshold. In some examples, insertion of the storage device 112 into the connector 110 couples the path 118 to ground. The first type of storage device is an eMMC storage device, for example. The low signal on the path 118 causes the switches 106, 108 to enable voltage signals to the storage device 112 via the connector 110. The switch 106 enables a 1.8 V voltage signal to propagate to a first terminal of the connector 110, and the switch 108 enables a 3.3 V to propagate to a second terminal of the connector 110, for example. In some examples, the voltage supply circuit 104 continuously supplies the 1.8 V voltage signal to the switch 106 and the 3.3V voltage signal to the switch 108. In other examples, the controller 102 causes the voltage supply circuit 104 to supply the 1.8 V voltage signal and the 3.3V voltage signal. A first voltage input of the storage device 112 is coupled to the first terminal of the connector 110, and a second voltage input of the storage device 112 is coupled to the second terminal of the connector 110, for example. The low signal on the path 118 is received by the control inputs of the buffers 114, 116 and enables the communications bus coupled to the storage device 112 and the controller 102. For example, the buffer 114 enables signals transmitted by the storage device 112 to propagate along the path 122 to the controller 102. The buffer 116 enables signals transmitted by the controller 102 to propagate along the path 120 to the storage device 112. The controller 102 transmits signals such as a clock signal, a command signal, a reset signal, a strobe signal, or a combination thereof, via the path 120, for example. The storage device 112 transmits signals such as responses to commands, data, or a combination thereof, via the path 122, for example.

While the path 120, 122 is shown as unidirectional, in some examples, the path 120, 122 is bi-directional. While the buffer 114, 116 is shown as unidirectional, in various examples, the buffer 114, 116 is bi-directional. In other examples, additional paths (not explicitly shown) between the controller 102 and the connector 110 include additional buffers. The additional paths (not explicitly shown), buffers, or a combination thereof, may be unidirectional, bi-directional, or a combination thereof.

In some examples, responsive to a second type of storage device coupling to the connector 110 and not driving the signal on the path 118 low, the signal on the path 118 is high. High, as used herein, indicates that a value of the signal on the path 118 is equivalent to or exceeds the specified threshold. In some examples, a resistor coupled to the path 118 and a voltage supply circuit (e.g., the voltage supply circuit 104, a voltage supply circuit not explicitly shown) causes the signal on the path 118 to be high. The second type of storage device is an NVMe storage device, for example. Responsive to the high signal on the path 118, the switches 106, 108 disable voltage signals to the connector 110. Responsive to the high signal on the path 118, the buffers 114, 116 disable the communications bus that is coupled to the connector 110. In some examples, responsive to the high signal on the path 118, another set of switches (not explicitly shown) enables other voltage signals signal to the connector 110, another set of buffers (not explicitly shown) enables another communications bus (not explicitly shown) that is coupled to the connector 110, or a combination thereof.

In various examples, the electronic device 100 includes the connector 110, the switch 106 to control, responsive to the signal on the path 118, providing of a first voltage signal to the connector 110, the switch 108 to control, responsive to the signal on the path 118, providing of a second voltage signal to the connector 110, and the controller 102. The first voltage signal is a 1.8 V voltage signal, for example. The second voltage signal is a 3.3 V voltage signal, for example. In other examples, the first and the second voltage signals supply a first and a second voltage, respectively, of a range of voltages. For example, the first voltage is a lowest voltage of the range of voltages, and the second voltage is a highest voltage of the range of voltages. In various examples, the range of voltages is determined by operating standards or guidelines for the storage device 112. The controller 102 determines, responsive to the signal on the path 118, a type of the storage device 112, and enables, responsive to the type of the storage device 112, a set of signals to the connector 110.

For example, the signal on the path 118 is a signal having a first voltage in response to the storage device 112 having a first type and having a second voltage in response to the storage device 112 having a second type. The controller 102 determines the type of the storage device 112 by determining whether a voltage of the signal on the path 118 is the first voltage or the second voltage, or within a programmed range of the first voltage or the second voltage. Responsive to the voltage of the signal on the path 118 indicating that the type of the storage device 112 is the first type of storage device, the controller 102 enables a first set of signals to the connector 110. The first set of signals is determined by operating standards or guidelines for the first type of storage device. For example, responsive to the voltage of the signal on the path 118 indicating that the storage device 112 is an eMMC storage device, the controller 102 enables a clock signal, a command signal, a reset signal, a strobe signal, or a combination thereof, for the eMMC storage device. In various examples, the first set of signals traverses the path 120. Responsive to the voltage of the signal on the path 118 indicating that the type of the storage device 112 is the second type of storage device, the controller 102 enables a different set of signals to the connector 110. The different set of signals is determined by operating standards or guidelines for the second type of storage device. For example, responsive to the voltage of the signal on the path 118 indicating that the storage device 112 is of a type other than the eMMC storage device, the controller 102 enables a clock signal, a reset signal, or a combination thereof, for an NVMe storage device. In various examples, the different set of signals traverses other paths (not explicitly shown). For example, the communications bus for the first set of signals couples to terminals of the connector 110 specified by the specification or standard for the connector 110 as “No Connects” or “NC,” and the communications bus for the different set of signals couples to terminals of the connector 110 specified by the specification or standard for the connector 110 as terminals utilized for NVMe storage devices.

Utilizing the switches 106, 108, the buffers 114, 116, or the combination thereof, enables the electronic device 100 to support an eMMC storage device by utilizing the “No Connects.” Disabling the voltage, the communications bus, or a combination thereof, when the eMMC storage device is not detected (e.g., when the signal on the path 118 is high) enables normal operations when the electronic device 100 communicates with other types of storage devices that utilize the PCIe interface.

In various examples, the controller 102 compares the voltage of the signal on the path 118 to a first threshold voltage. Responsive to the voltage of the signal on the path 118 being equivalent to or exceeding the first threshold voltage, the controller 102 determines that the storage device 112 is a first type of storage device. For example, responsive to the voltage of the signal on the path 118 being equivalent to or exceeding the first threshold voltage, the controller 102 determines that the storage device 112 is a NVMe storage device. In some examples, responsive to the voltage of the signal on the path 118 being below the first threshold voltage, the controller 102 determines that the storage device 112 is a second type of storage device. For example, responsive to the voltage of the signal on the path 118 being below the first threshold voltage, the controller 102 determines that the storage device 112 is an eMMC storage device. In other examples, responsive to the voltage of the signal on the path 118 being below the first threshold voltage, the controller 102 compares the voltage of the signal to a second threshold voltage. Responsive to the voltage of the signal being equivalent to or below the second threshold voltage, the controller 102 determines that the storage device 112 is the second type of storage device.

In various examples, the controller 102 causes the voltage supply circuit 104 to supply a first voltage signal to the switch 106 and a second voltage signal to the switch 108. For example, the first voltage signal is a 1.8 V voltage signal and the second voltage signal is a 3.3 V voltage signal. In some examples, the controller 102 causes the voltage supply circuit 104 to supply the first and the second voltage signals in response to the type of the storage device 112 indicating a first type of storage device and causes the voltage supply circuit 104 to disable supply of the first and the second voltage signals in response to the type of the storage device 112 indicating a second type of storage device. For example, responsive to storage device 112 being an eMMC storage device, the controller 102 causes the voltage supply circuit 104 to supply the first and the second voltage signals, and responsive to the storage device 112 being an NVMe storage device, the controller 102 causes the voltage supply circuit 104 to disable supply of the first and the second voltage signals.

While the switches 106, 108 are shown to control the first and the second voltage signals, in some examples, the switches 106, 108 are omitted and the controller 102 causes the voltage supply circuit 104 to supply the first voltage signal and the second voltage signal responsive to the signal on the path 118. For example, responsive to a low signal on the path 118, the controller 102 determines the type of the storage device 112 is the first type of storage device and causes the voltage supply circuit 104 to supply the first voltage signal to the first terminal of the connector 110 and the second voltage signal to the second terminal of the connector 110. In various examples, responsive to a high signal on the path 118, the controller 102 determines the type of the storage device 112 is the second type of storage device and causes the voltage supply circuit 104 to supply a third voltage signal to the first terminal of the connector 110 and a fourth voltage signal to the second terminal of the connector 110.

While the buffers 114, 116 are shown to control the communications bus, in some examples, the buffers 114, 116 are omitted and the controller 102 controls transmission of signals responsive to the type of the storage device 112. For example, responsive to a low signal on the path 118, the controller 102 determines the type of the storage device 112 is the first type of storage device. Responsive to the determination that the storage device 112 is the first type of storage device, the controller 102 transmits a set of signals to the storage device 112 via the path 120 and receives signals from the storage device 112 via the path 122. In various examples, responsive to a high signal on the path 118, the controller 102 determines the type of the storage device 112 is the second type of storage device. Responsive to the determination that the storage device 112 is the second type of storage device, the controller 102 does not transmit the set of signals to the storage device 112 via the path 120 and ignores signals from the storage device 112 via the path 122.

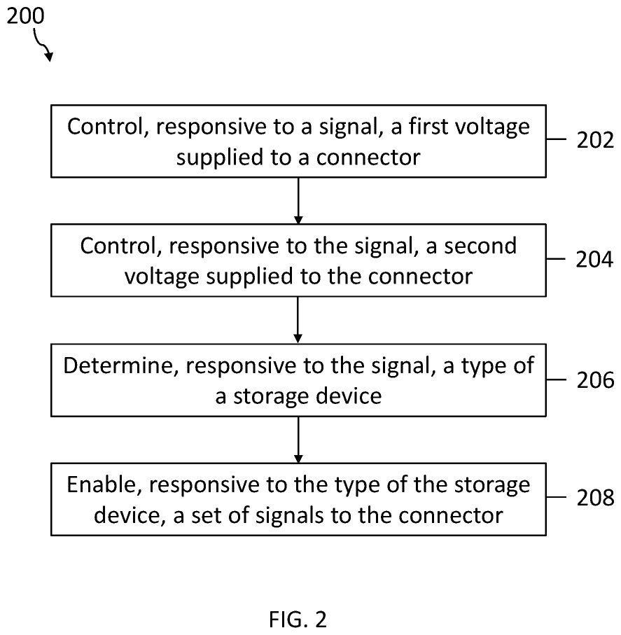

Referring now to FIG. 2, a flow diagram depicting a method 200 for an electronic device (e.g., the electronic device 100) to enable a storage device (e.g., the storage device 112) to couple to a communications bus (e.g., the paths 120, 122) is provided, in accordance with various examples. The method 200 includes controlling, responsive to a signal (e.g., the signal on the path 118), a first voltage signal to a connector (e.g., the connector 110) (202). The method 200 also includes controlling, responsive to the signal, a second voltage signal to the connector (204). Additionally, the method 200 includes determining, responsive to the signal, a type of a storage device (e.g., the storage device 112) (206). Responsive to the type of the storage device, the method 200 also includes enabling a set of signals to the connector (208).

As described above with respect to FIG. 1, in some examples, the electronic device includes a first switch (e.g., the switch 106) to control, responsive to the signal (e.g., the signal received via the path 118), providing of the first voltage signal to the connector, a second switch (e.g., the switch 108) to control, responsive to the signal, providing of the second voltage signal to the connector, and a controller (e.g., the controller 102). In various examples, utilizing the techniques described above with respect to FIG. 1, the controller determines, responsive to the signal, a type of the storage device, and enables, responsive to the type of the storage device, the set of signals to the connector.

In various examples, as described above with respect to FIG. 1, the electronic device includes a controller to control, responsive to the signal, providing of the first voltage signal to the connector and the second voltage signal to the connector. For example, responsive to the type of the storage device indicating an eMMC storage device, the controller causes a voltage supply circuit (e.g., the voltage supply circuit 104) to supply a 1.8 V voltage signal and a 3.3 V voltage signal to the connector. Responsive to the type of the storage device indicating an NVMe storage device, the controller causes the voltage supply circuit to disable the first and the second voltage signals to the connector. In various examples, the controller receives the signal and determines the type of the storage device utilizing techniques described above with respect to FIG. 1. Responsive to the signal having a first value (e.g., indicating a first type of storage device), the controller causes the voltage supply circuit to supply the first voltage signal to the first switch, the second voltage signal to the second switch, or a combination thereof. Responsive to the signal having a second value (e.g., indicating a second type of storage device), the controller causes the voltage supply circuit to disable supply of the first voltage signal to the first switch, the second voltage signal to the second switch, or a combination thereof.

In some examples, as described above with respect to FIG. 1, the controller controls transmission of signals responsive to the type of the storage device. For example, responsive to the signal having a value below a first threshold, the controller determines that the type of the storage device is the first type of storage device. Responsive to the determination that the storage device is the first type of storage device, the controller enables a first set of signals to be transmitted to the storage device via a first communications bus and receives signals from the storage device via the first communications bus. In various examples, responsive to the signal having a value that is equivalent to or exceeds a second threshold, the controller determines that the type of the storage device is the second type of storage device. Responsive to the determination that the storage device is the second type of storage device, the controller enables a second set of signals to be transmitted to the storage device via a second communications bus and receives signals from the storage device via the second communications bus. In some examples, the first communications bus and the second communications bus have an overlapping signal path or multiple overlapping signal paths. The overlapping signal path or the multiple overlapping signal paths are for data signals and nonoverlapping signal paths are for command signals, clock signals, reset signals, strobe signals, or a combination thereof, for example.

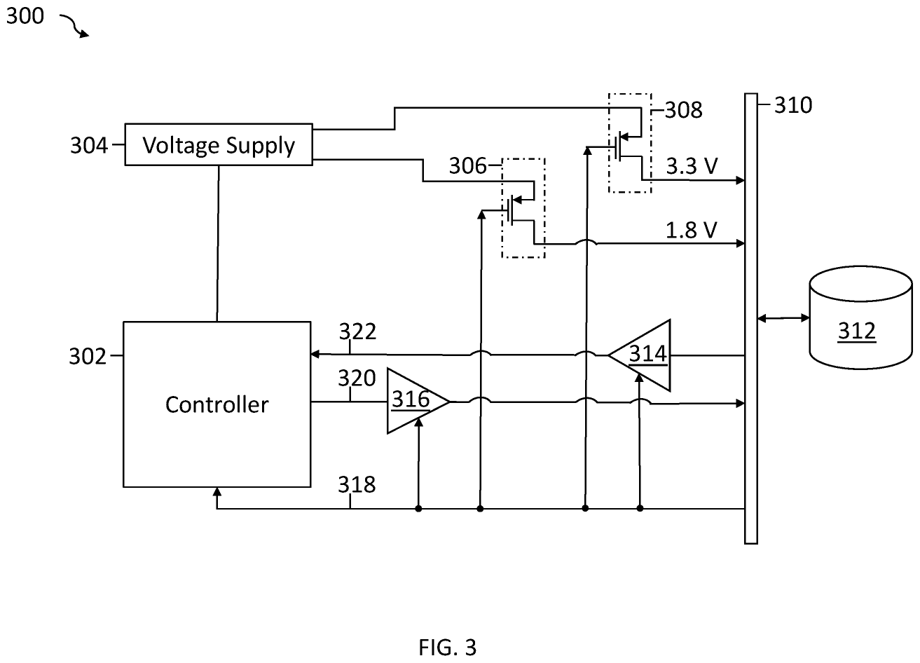

Referring now to FIG. 3, a block diagram depicting an electronic device 300 for enabling a storage device 312 to couple to a communications bus is provided, in accordance with various examples. The electronic device 300 is the electronic device 100, for example. The electronic device 300 includes a controller 302, a voltage supply circuit 304, transistors 306, 308, a connector 310, the storage device 312, buffers 314, 316, and paths 318, 320, 322. The paths 320, 322 are herein referred to collectively as the communications bus. The controller 302 is the controller 102, for example. The voltage supply circuit 304 is the voltage supply circuit 104, for example. The transistors 306, 308 are the switches 106, 108, for example. The connector 310 is the connector 110, for example. The storage device 312 is the storage device 112, for example. The buffers 314, 316 are the buffers 114, 116, respectively, for example. The paths 318, 320, 322 are the paths 118, 120, 122, respectively, for example.

In various examples, the controller 302 is coupled to the voltage supply circuit 304, a first terminal of the connector 310 via the path 318, a gate of the transistor 306 via the path 318, a gate of the transistor 308 via the path 318, and control inputs of the buffers 314, 316, respectively, via the path 318, an output of the buffer 314 via the path 322, and a data input of the buffer 316 via the path 320. The voltage supply circuit 304 is coupled to the controller 302, a source of the transistor 306, and a source of the transistor 308. The source of the transistor 306 is coupled to the voltage supply circuit 304, the drain of the transistor 306 is coupled to a second terminal of the connector 310 via a path 1.8 V, and the gate of the transistor 306 is coupled to the gate of the transistor 308 via the path 318, the control inputs of the buffers 314, 316 via the path 318, and the controller 302 via the path 318. The source of the transistor 308 is coupled to the voltage supply circuit 304, the drain of the transistor 308 is coupled to a third terminal of the connector 310 via a path 3.3 V, and the gate of the transistor 308 is coupled to the gate of the transistor 306 via the path 318, the control inputs of the buffers 314, 316 via the path 318, and the controller 302 via the path 318. Via the path 318, the first terminal of the connector 310 is coupled to the controller 302, the gate of the transistor 306, the gate of the transistor 308, and the control inputs of the buffers 314, 316, respectively. The second terminal of the connector 310 is coupled to the drain of the transistor 306 via the 1.8 V path. The third terminal of the connector 310 is coupled to the drain of the transistor 308 via the 3.3 V path. A fourth terminal of the connector 310 is coupled to a data input of the buffer 314 via the path 322. A fifth terminal of the connector 310 is coupled to an output of the buffer 316 via the path 320. The storage device 312 is coupled to the first, second, third, fourth, and fifth terminals of the connector 310.

The data input of the buffer 314 is coupled to the fourth terminal of the connector 310 via the path 322. The control input of the buffer 314 is coupled to the controller 302, the gate of the transistor 306, the gate of the transistor 308, and the control input of the buffer 316 via the path 318. The output of the buffer 314 is coupled to the controller 302 via the path 322. The output of the buffer 316 is coupled to the fifth terminal of the connector 310 via the path 320. The control input of the buffer 316 is coupled to the controller 302, the gate of the transistor 306, the gate of the transistor 308, and the control input of the buffer 314 via the path 318. The data input of the buffer 316 is coupled to the controller 302 via the path 320. The path 318 is coupled to the controller 302, the gate of the transistor 306, the gate of the transistor 308, the first terminal of the connector 310, and the control inputs of the buffers 314, 316. The path 320 is coupled to the data input of the buffer 316 and the controller 302 and to the output of the buffer 316 and the fifth terminal of the connector 310. The path 322 is coupled to the data input of the buffer 314 and the fourth terminal of the connector 310 and to the controller 302 and the output of the buffer 314.

As described above with respect to FIG. 1, the electronic device 300 utilizes the transistors 306, 308, the buffers 314, 316, or a combination thereof, to enable and disable the flow of signals to and from the storage device 312 via the connector 310. The electronic device 300 utilizes a signal on the path 318 to control the transistors 306, 308, the buffers 314, 316, or a combination thereof, for example. In various examples, the electronic device 300 utilizes the signal on the path 318 to control the transistors 306, 308 to enable and disable voltage signals to the storage device 312 via the connector 310. In some examples, the electronic device 300 utilizes the signal on the path 318 to control the buffers 314, 316 to control transmission of signals between the controller 302 and the storage device 312 via the communications bus. For example, the buffer 316 controls, responsive to the signal on the path 318, transmission of signals from the controller 302 to the storage device 312 via the path 320. The buffer 314 controls, responsive to the signal on the path 318, transmission of signals from the storage device 312 to the controller 302 via the path 322.

In some examples, the electronic device 300 includes the connector 310, the transistor 306 to control, responsive to the signal received from the connector 310 via the path 318, providing of a first voltage signal to the connector 310, the transistor 308 to control, responsive to the signal received from the connector 310 via the path 318, providing of a second voltage signal to the connector 310, and the buffer 316 to control propagation of signals from the controller 302 to the connector 310. The first voltage signal is a 1.8 V voltage signal, for example. The second voltage signal is a 3.3 V voltage signal, for example. In other examples, as described above with respect to FIG. 1, the first and the second voltage signals have a first and a second voltage, respectively, of a range or voltages determined by operating standards or guidelines for the storage device 312. As described above with respect to FIG. 1, the set of signals controlled by the buffer 316 are determined by operating standards or guidelines for the storage device 312, in some examples. In other examples, the electronic device 300 includes the buffer 314 to control propagation of signals from the connector 310 to the controller 302.

In various examples, the transistors 306, 308 are p-channel field effect transistors (FETs), such as metal oxide semiconductor FETs (MOSFETs). As described above with respect to FIG. 1, in various examples, responsive to a first type of storage device coupling to the connector 310, a signal on the path 318 is driven low. The low signal on the path 318 is received at gates of the transistors 306, 308. The low signal at the gates of the transistors 306, 308 and a high signal supplied by the voltage supply circuit 304 at the sources of the transistors 306, 308 enable voltage signals to flow from the voltage supply circuit 304 to the storage device 312 via the connector 310. For example, the transistor 306 enables a 1.8 V voltage signal to propagate to the second terminal of the connector 310, and the transistor 308 enables a 3.3 V voltage signal to propagate to the third terminal of the connector 310. The low signal on the path 318 received by the control inputs of the buffers 314, 316 enables the communications bus that is coupled to the controller 302 and the storage device 312 via the connector 310. For example, the buffer 314 enables signals transmitted by the storage device 312 to propagate along the path 322 to the controller 302. The buffer 316 enables signals transmitted by the controller 302 to propagate along the path 320 to the storage device 312.

In some examples, responsive to a second type of storage device coupling to the connector 310, the signal on the path 318 is high, as described above with respect to FIG. 1. The high signal on the path 318 causes the transistors 306, 308 to disable the voltage signal supplied by the voltage supply circuit 304 from flowing to the storage device 312 via the second and the third terminals of connector 310. The high signal on the path 318 received at the control inputs of the buffers 314, 316 disables the communications bus that is coupled to the controller 302 and the storage device 312 via the connector 310.

In various examples, the controller 302 is coupled to the voltage supply circuit 304. As described above with respect to FIGS. 1 and 2, in some examples, the controller 302 causes, responsive to the signal on the path 318 having the low value, the voltage supply circuit 304 to supply the first and the second voltage signals to the source of the transistor 306 and the source of the transistor 308, respectively.

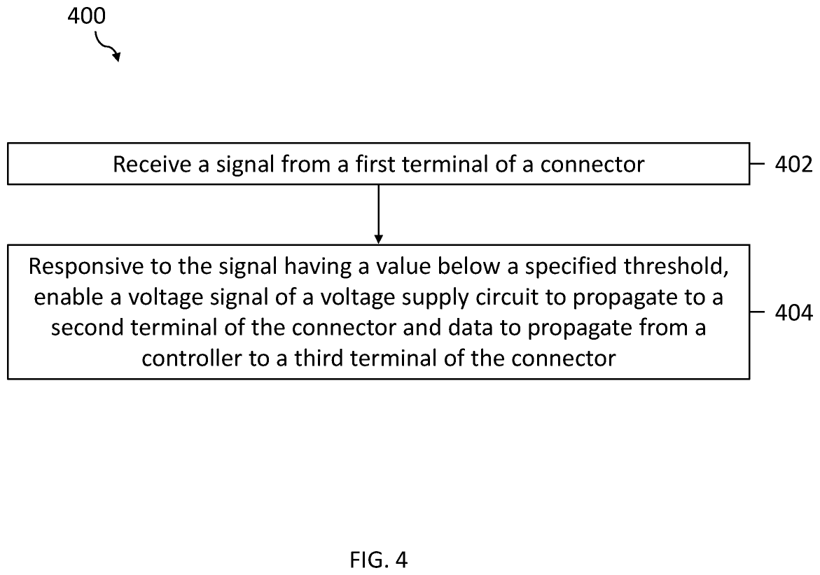

Referring now to FIG. 4, a flow diagram depicting a method 400 for an electronic device (e.g., the electronic device 100, 300) to enable a storage device (e.g., the storage device 112, 312) to couple to a communications bus (e.g., the paths 120, 122, the paths 320, 322) is provided, in accordance with various examples. The method 400 includes receiving a signal (e.g., the signal on the path 118, 318) from a first terminal of a connector (e.g., the connector 110, 310) (402). Responsive to the signal having a value below a specified threshold, the method 400 also includes enabling a voltage signal of a voltage supply circuit (e.g., the voltage supply circuit 104, 304) to propagate to a second terminal of the connector and signals to propagate from a controller (e.g., the controller 102, 302) to a third terminal of the connector (404).

As described above with respect to FIG. 3, in some examples, the electronic device includes the connector having multiple terminals. The connector is to couple to a storage device (e.g., the storage device 312). The electronic device includes a transistor (e.g., the transistor 306) having a gate to receive a signal from a first terminal of the connector (e.g., the signal on the path 318), a source coupled to a voltage supply circuit (e.g., the voltage supply circuit 304), and a drain coupled to a second terminal of the connector. The transistor is to enable a voltage signal of the voltage supply circuit to propagate to the second terminal of the connector responsive to the signal having the value below the specified threshold. The electronic device includes a buffer (e.g., the buffer 314) having a control input to receive the signal from the first terminal of the connector, a data input coupled to a controller (e.g., the controller 302), and an output coupled to a third terminal of the connector. The buffer is to enable signals to propagate from the controller to the third terminal of the connector responsive to the signal having the value below the specified threshold. In various examples, responsive to the signal having a value that is equivalent to or exceeds the specified threshold, the transistor is to disable the voltage signal of the voltage supply circuit from propagating to the second terminal of the connector, and the buffer is to disable signals from propagating from the controller to the third terminal of the connector.

As described above with respect to FIG. 3, in some examples, the electronic device includes a second transistor (e.g., the transistor 308) having a second gate to receive the signal from the first terminal of the connector, a second source coupled to the voltage supply circuit, and a second drain coupled to a fourth terminal of the connector. The second transistor is to enable a second voltage signal of the voltage supply circuit to propagate to the fourth terminal of the connector responsive to the signal having the value below the specified threshold. The second transistor is to disable the second voltage signal of the voltage supply circuit from propagating to the fourth terminal of the connector responsive to the signal having a value that is equivalent to or exceeds the specified threshold.

In various examples, as described above with respect to FIG. 3, the electronic device includes a second buffer (e.g., the buffer 316) having a second control input to receive the signal from the first terminal of the connector, a second data input coupled to the controller, and a second output coupled to a fourth terminal of the connector. Responsive to the signal having the value that is equivalent to or exceeds a specified threshold, the second buffer is to enable a second set of signals to propagate from the fourth terminal of the connector to the controller. Responsive to the signal having a value that is below the specified threshold, the second buffer is to disable the second set of signals from propagating from the fourth terminal of the connector to the controller. For example, the second buffer is coupled to a second communication bus of the electronic device. The second communication bus is coupled to a NVMe storage device, for example.

In some examples, as described above with respect to FIG. 1, responsive to a first type of storage device coupling to the connector, the signal is driven to have the value below the specified threshold, and responsive to a second type of storage device coupling to the connector, the signal has a value that is equivalent to or exceeds the specified threshold. For example, the first type of storage device is an eMMC storage device, and the second type of storage device is an NVMe storage device. In some examples, as described above with respect to FIG. 3, the controller is coupled to the voltage supply circuit and causes, responsive to the signal having the value below the specified threshold, the voltage supply circuit to supply the voltage signal and the second voltage signal to the source and the second source, respectively, of the transistor and the second transistor, respectively.

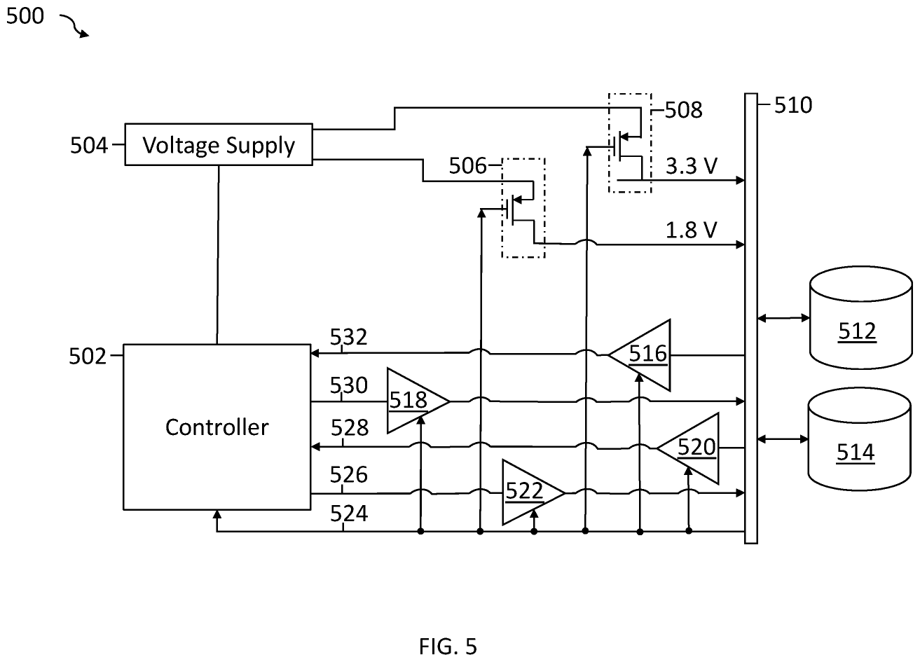

Referring now to FIG. 5, a block diagram depicting an electronic device 500 for enabling storage devices 512, 514 to couple to a communications bus is provided, in accordance with various examples. The electronic device 500 is the electronic device 100, 300, for example. The electronic device 500 includes a controller 502, a voltage supply circuit 504, transistors 506, 508, a connector 510, the storage devices 512, 514, buffers 516, 518, 520, 522, and paths 524, 526, 528, 530, 532. The buffers 516, 518, 520, 522 are herein referred to collectively as the buffers 516-522. The paths 526, 528, 530, 532 are herein referred to collectively as the paths 526-532 or the communications bus. In some examples, the paths 526, 528 are a first communications bus and the paths 530, 532 are a second communications bus. The controller 502 is the controller 102, 302, for example. The voltage supply circuit 504 is the voltage supply circuit 104, 304, for example. The transistors 506, 508 are the transistors 306, 308 or the switches 106, 108, for example. The connector 510 is the connector 110, 310, for example. The storage device 512 is the storage device 112, 312, for example. The storage device 514 is the storage device 112, 312, for example. The buffers 516, 518 are the buffers 114, 116, respectively, or the buffers 314, 316, respectively, for example. The buffers 520, 522 are the buffers 114, 116, respectively, or the buffers 314, 316, respectively, for example.

In various examples, the controller 502 is coupled to the voltage supply circuit 504, a first terminal of the connector 510 via the path 524, a gate of the transistor 506 via the path 524, a gate of the transistor 508 via the path 524, and control inputs of the buffers 516-522, respectively, via the path 524, an output of the buffer 516 via the path 532, a data input of the buffer 518 via the path 530, an output of the buffer 520 via the path 528, and a data input of the buffer 522 via the path 526. The voltage supply circuit 504 is coupled to the controller 502, a source of the transistor 506, and a source of the transistor 508. The source of the transistor 506 is coupled to the voltage supply circuit 504, the drain of the transistor 506 is coupled to a second terminal of the connector 510 via a path 1.8 V, and the gate of the transistor 506 is coupled to the gate of the transistor 508 via the path 524, the control inputs of the buffers 516-522 via the path 524, and the controller 502 via the path 524. The source of the transistor 508 is coupled to the voltage supply circuit 504, the drain of the transistor 508 is coupled to a third terminal of the connector 510 via a path 3.3 V, and the gate of the transistor 508 is coupled to the gate of the transistor 506 via the path 524, the control inputs of the buffers 516-522 via the path 524, and the controller 502 via the path 524. Via the path 524, the first terminal of the connector 510 is coupled to the controller 502, the gate of the transistor 506, the gate of the transistor 508, and the control inputs of the buffers 516-522, respectively. The second terminal of the connector 510 is coupled to the drain of the transistor 506 via the 1.8 V path. The third terminal of the connector 510 is coupled to the drain of the transistor 508 via the 3.3 V path. A fourth terminal of the connector 510 is coupled to a data input of the buffer 516 via the path 532. A fifth terminal of the connector 510 is coupled to an output of the buffer 518 via the path 530. A sixth terminal of the connector 510 is coupled to a data input of the buffer 520 via the path 528. A seventh terminal of the connector 510 is coupled to an output of the buffer 522 via the path 526. The storage device 512 is coupled to the connector 510. The storage device 514 is coupled to the connector 510.

The data input of the buffer 516 is coupled to the fourth terminal of the connector 510 via the path 532. The control input of the buffer 516 is coupled to the controller 502, the gate of the transistor 506, the gate of the transistor 508, and the control inputs of the buffer 518, 520, 522 via the path 524. The output of the buffer 516 is coupled to the controller 502 via the path 532. The output of the buffer 518 is coupled to the fifth terminal of the connector 510 via the path 530. The control input of the buffer 518 is coupled to the controller 502, the gate of the transistor 506, the gate of the transistor 508, and the control inputs of the buffers 516, 520, 522 via the path 524. The data input of the buffer 518 is coupled to the controller 502 via the path 530. The data input of the buffer 520 is coupled to the sixth terminal of the connector 510 via the path 528. The control input of the buffer 520 is coupled to the controller 502, the gate of the transistor 506, the gate of the transistor 508, and the control inputs of the buffer 516, 518, 522 via the path 524. The output of the buffer 520 is coupled to the controller 502 via the path 528. The output of the buffer 522 is coupled to the seventh terminal of the connector 510 via the path 526. The control input of the buffer 522 is coupled to the controller 502, the gate of the transistor 506, the gate of the transistor 508, and the control inputs of the buffers 516, 518, 520 via the path 524. The data input of the buffer 522 is coupled to the controller 502 via the path 526. The path 524 is coupled to the controller 502, the gate of the transistor 506, the gate of the transistor 508, the first terminal of the connector 510, and the control inputs of the buffers 516, 518, 520, 522. The path 526 is coupled to the data input of the buffer 522 and the controller 502 and to the output of the buffer 522 and the seventh terminal of the connector 510. The path 528 is coupled to the data input of the buffer 520 and the sixth terminal of the connector 510 and to the controller 502 and the output of the buffer 520. The path 530 is coupled to the data input of the buffer 518 and the controller 502 and to the output of the buffer 518 and the fifth terminal of the connector 510. The path 532 is coupled to the data input of the buffer 516 and the fourth terminal of the connector 510 and to the controller 502 and the output of the buffer 516.

In some examples, the transistors 506, 508 are p-channel FETs. As described above with respect to FIG. 3, in various examples, responsive to a first type of storage device coupling to the connector 510, a signal on the path 524 is driven low. The low signal on the path 524 causes the transistors 506, 508 to enable voltage signal by the voltage supply circuit 504 to flow to the storage device 512 via the connector 510. For example, the transistor 506 enables a 1.8 V voltage signal to propagate to the second terminal of the connector 510, and the transistor 508 enables a 3.3 V voltage signal to propagate to the third terminal of the connector 510. The low signal on the path 524 received by the control inputs of the buffers 516-522 enable the communications bus that is coupled to the controller 502 and the storage device 512 via the connector 510. For example, the buffers 516, 520 enable signals transmitted by the storage device 512 to propagate along the paths 532, 528, respectively, to the controller 502. The buffers 518, 522 enable signals transmitted by the controller 502 to propagate along the paths 530, 526, respectively, to the storage device 512.

In various examples, responsive to a second type of storage device coupling to the connector 510, the signal on the path 524 is high, as described above with respect to FIG. 1. The high signal on the path 524 causes the transistors 506, 508 to disable voltage signal by the voltage supply circuit 504 from flowing to the storage device 512 via the connector 510. The high signal on the path 524 received by the control inputs of the buffers 516-522 disables the communications bus that is coupled to the controller 502 and the storage device 512 via the connector 510.

In some examples, as described above with respect to FIG. 1, the controller 502 determines a type of the storage device 512 by determining whether a voltage of the signal on the path 524 is the first voltage or the second voltage. Responsive to the voltage of the signal on the path 524 indicating that the type of the storage device 512 is the first type of storage device, the controller 502 enables a first set of signals to the connector 510. The first set of signals are determined by operating standards or guidelines for the first type of storage device. For example, responsive to the voltage of the signal on the path 524 indicating that the storage device 512 is an eMMC storage device, the controller 502 enables a clock signal, a command signal, a reset signal, a strobe signal, or a combination thereof, for the eMMC storage device. In various examples, the first set of signals traverses the first communications bus. Responsive to the voltage of the signal on the path 524 indicating that the type of the storage device 514 is the second type of storage device, the controller 502 enables a second set of signals to the connector 510. The second set of signals are determined by operating standards or guidelines for the second type of storage device. For example, responsive to the voltage of the signal on the path 524 indicating that the storage device 512 is an NVMe storage device, the controller 502 enables a clock signal, a reset signal, or a combination thereof, for the NVMe storage device. In various examples, the second set of signals traverses the second communication. The first communications bus for the first set of signals couples to terminals of the connector 510 specified by the specification or standard for the connector 510 as “No Connects” or “NC,” and the second communications bus for the second set of signals couples to terminals of the connector 510 specified by the specification or standard for the connector 510 as terminals utilized for NVMe storage devices.

Utilizing the transistors 506, 508, the buffers 516-522, or the combination thereof, enables the electronic device 500 to support an eMMC storage device by utilizing the “No Connects” and an NVMe storage device. Disabling the voltage, the first communications bus, or a combination thereof, when the eMMC storage device is not in use enables normal operations of the NVMe storage device.

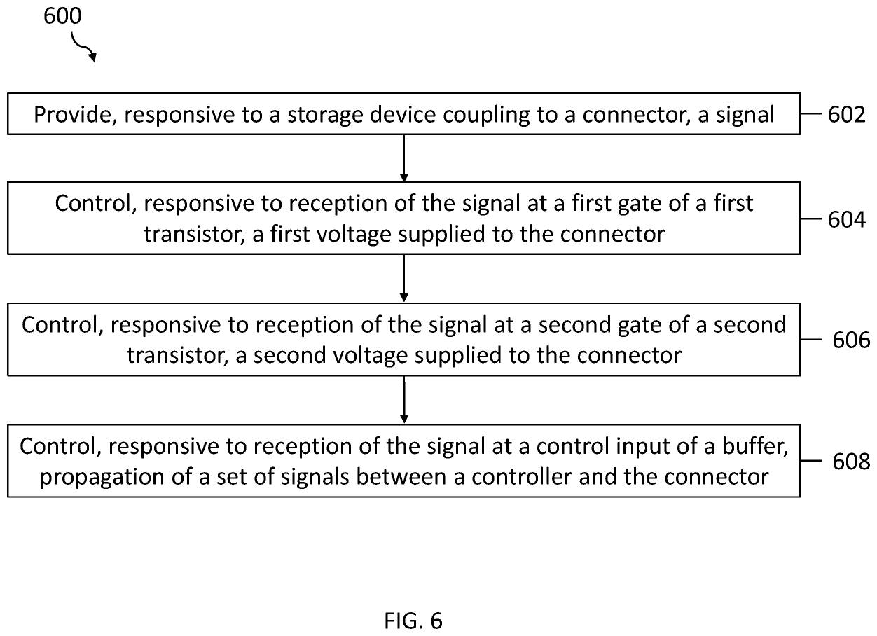

Referring now to FIG. 6, a flow diagram depicting a method 600 of an electronic device (e.g., the electronic device 100, 300, 500) to enable a storage device (e.g., the storage device 112, 312, 512, 514) to couple to a communications bus is provided, in accordance with various examples. The method 600 includes providing, responsive to the storage device coupling to a connector (e.g., the connector 110, 310, 510), a signal (e.g., the signal on the path 118, 318, 524) (602). The method 600 also includes controlling, responsive to reception of the signal at a first gate of a first transistor (e.g., the transistor 306, 506), a first voltage signal to the connector (604). Responsive to reception of the signal at a second gate of a second transistor (e.g., the transistor 308, 508), a second voltage signal to the connector (606). Additionally, the method 600 includes controlling, responsive to reception of the signal at a control input of a buffer, propagation of a set of signals between a controller (e.g., the controller 102, 302, 502) and the connector (608).

As described above with respect to FIG. 5, the electronic device includes the connector to couple to a storage device (e.g., the storage device 512, 514), the coupling to provide a signal, the signal having a first value responsive to the storage device having a first type and a second value responsive to the storage device having a second type. The electronic device includes a first transistor (e.g., the transistor 506) to control, responsive to reception of the signal at a first gate, providing of a first voltage signal to the connector, a second transistor (e.g., the transistor 508) to control, responsive to reception of the signal at a second gate, providing of a second voltage signal to the connector, and a buffer (e.g., the buffer 516) to control, responsive to reception of the signal at a control input, propagation of a set of signals between a controller (e.g., the controller 502) and the connector. In various examples, the controller is to enable, responsive to the signal having the first value, a first set of signals to the connector, and enable, responsive to the signal having the second value, a second set of signals to the connector. In some examples, the first type of storage device is an Embedded MultiMedia Card (eMMC) storage device and the second type of storage device is a Non-Volatile Memory Express (NVMe) storage device.

In other examples, the electronic device includes a multiplexer (not explicitly shown) to enable, responsive to the type of the storage device indicating a first type of storage device, the first set of signals to the connector; and to enable, responsive to the type of the storage device indicating a second type of storage device, the second set of signals to the connector. In some examples, the multiplexer enables the first set of signals to traverse a first communications bus (e.g., the paths 530, 532) and the second set of signals to traverse a second communications bus (e.g., the paths 526, 528). In various examples, as described above with respect to FIG. 1, the first communications bus and the second communications bus have overlapping signal paths, such as paths for data signals.

While components and circuits of the electronic device 100, 300, 500 described herein are shown as discrete components and circuits, in other examples, the components, circuits, or a combination thereof are integrated circuits (IC) that perform some or all the actions attributed to the discrete components, circuits, or combination thereof, included in the IC. Except where infeasible (e.g., block functionality of a component, a circuit, or a combination thereof), the components, circuits, or a combination thereof, may be included in an IC. For example, the buffers 114, 116 are a buffer IC. While the storage device 112, 312, 512, 514 are shown herein as internal to the electronic device 100, 300, 500, respectively, in some examples, the storage device 112, 312, 512, 514 is an external enclosure that couples to the connector 110, 310, 510, respectively.

Unless infeasible, some or all of the method 200, 400, 600 may be performed by the electronic device 100, 300, 500 concurrently or in different sequences and by circuity of the electronic device 100, 300, 500, machine-readable instructions, or a combination thereof. For example, the method 200, 400, 600 is implemented by machine-readable instructions stored to a storage device (e.g., the storage device 112, 312, 512, 514, or another storage device not explicitly shown) of the electronic device 100, 300, 500, circuitry (some of which is not explicitly shown) of the electronic device 100, 300, 500, or a combination thereof. The controller 102, 302, 502 of the electronic device 100, 300, 500 executes the machine-readable instructions to perform some or all of the method 200, 400, 600, for example. In another example, comparators (not explicitly shown) couple to the controller 102, 302, 502, a multiplexer (not explicitly shown), or some combination thereof. The comparators determine whether values are below or exceed particular thresholds, and the multiplexer selects a communications bus for signals to propagate between the controller 102, 302, 502 and the storage device 112, 312, 512, 514 based on the outputs of the comparators, for example.

Utilizing the method 200, 400, 600 enables the electronic device 100, 300, 500 to support an eMMC storage device, which provides high capacity storage while utilizing less voltage than other types of storage devices. The electronic device 100, 300, 500 interchangeably supports both the eMMC storage device and other types of storage devices that utilize the PCIe interface via a same connector (e.g., the connector 110, 310, 510) without additional hardware components. Additionally, the method 200, 400, 600 does not interfere with operations when the electronic device 100, 300, 500 communicates with other types of storage devices that utilize the PCIe interface via the connector.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . ” Also, the term “couple” or “is coupled” is intended to be broad enough to encompass both direct and indirect connections. Thus, if a first device is coupled to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a connector;
a first switch to control, responsive to a signal, providing of a first voltage signal to the connector;
a second switch to control, responsive to the signal, providing of a second voltage signal to the connector; and
a controller to:
determine, responsive to the signal, a type of a storage device coupled to the connector; and
enable, responsive to the type of the storage device, a set of signals to the connector.

2. The electronic device of claim 1, wherein the signal is a voltage signal having a first voltage in response to the storage device having a first type and having a second voltage in response to the storage device having a second type.

3. The electronic device of claim 1, wherein the controller is to:
enable, responsive to the type of the storage device indicating a first type of storage device, a first set of signals to the connector; and
enable, responsive to the type of the storage device indicating a second type of storage device, a second set of signals to the connector.

4. The electronic device of claim 3, wherein the first set of signals traverse a first communications bus and the second set of signals traverse a second communications bus.

5. The electronic device of claim 1, comprising:
a first buffer to control, responsive to the signal, transmission of the set of signals from the controller to the storage device; and
a second buffer to control, responsive to the signal, the transmission of the set of signals from the storage device to the controller.

6. An electronic device, comprising:
a connector having multiple terminals, the connector to couple to a storage device;
a transistor having a gate to receive a signal from a first terminal of the connector, a source coupled to a voltage supply circuit, and a drain coupled to a second terminal of the connector, the transistor to enable a voltage signal of the voltage supply circuit to propagate to the second terminal of the connector responsive to the signal having a value below a specified threshold; and
a buffer having a control input to receive the signal from the first terminal of the connector, a data input coupled to a controller, and an output coupled to a third terminal of the connector, the buffer to enable a set of signals to propagate from the controller to the third terminal of the connector responsive to the signal having the value below the specified threshold.

7. The electronic device of claim 6, wherein responsive to the signal having a second value that is equivalent to or exceeds the specified threshold, the transistor is to disable the voltage signal of the voltage supply circuit from propagating to the second terminal of the connector and the buffer is to disable the set of signals from propagating from the controller to the third terminal of the connector.

8. The electronic device of claim 6, comprising:
a second transistor having a second gate to receive the signal from the first terminal of the connector, a second source coupled to the voltage supply circuit, and a second drain coupled to a fourth terminal of the connector;
wherein the second transistor is to enable a second voltage signal of the voltage supply circuit to propagate to the fourth terminal of the connector responsive to the signal having the value below the specified threshold; and
wherein the second transistor is to disable the second voltage signal of the voltage supply circuit from propagating to the fourth terminal of the connector responsive to the signal having a second value that is equivalent to or exceeds the specified threshold.

9. The electronic device of claim 8, wherein the controller is coupled to the voltage supply circuit, the controller to cause, responsive to the signal having the value below the specified threshold, the voltage supply circuit to supply the voltage signal and the second voltage signal to the source and the second source, respectively, of the transistor and the second transistor, respectively.

10. The electronic device of claim 6, comprising:
a second buffer having a second control input to receive the signal from the first terminal of the connector, a second data input coupled to the controller, and a second output coupled to a fourth terminal of the connector;
wherein responsive to the signal having a second value that is equivalent to or exceeds the specified threshold, the second buffer is to enable a second set of signals to propagate from the fourth terminal of the connector to the controller; and
wherein responsive to the signal having the value that is below the specified threshold, the second buffer is to disable the second set of signals from propagating from the fourth terminal of the connector to the controller.

11. An electronic device, comprising:
a connector to couple to a storage device, the coupling to provide a signal, the signal having a first value responsive to the storage device having a first type and a second value responsive to the storage device having a second type;
a first transistor to control, responsive to reception of the signal at a first gate, providing of a first voltage signal to the connector;
a second transistor to control, responsive to reception of the signal at a second gate, providing of a second voltage signal to the connector; and
a buffer to control, responsive to reception of the signal at a control input, propagation of a set of signals between a controller and the connector.

12. The electronic device of claim 11, wherein the connector is an M.2 connector.

13. The electronic device of claim 11, wherein the first and the second transistors are p-channel field effect transistors (FETs).

14. The electronic device of claim 11, wherein the controller is to:
enable, responsive to the signal having the first value, a first set of signals to traverse a first communications bus;
enable, responsive to the signal having the second value, a second set of signals to traverse a second communications bus; and
wherein the first communications bus and the second communications bus have an overlapping signal path.

15. The electronic device of claim 14, wherein the first type indicates an Embedded MultiMedia Card (eMMC) storage device and the second type indicates a Non-Volatile Memory Express (NVMe) storage device.
